(19) United States
(12) Patent Application Publication
(10) Pub. No.: US 2012/0072020 A1
(43) Pub. Date: Mar. 22, 2012

(54) METHOD AND APPARATUS FOR DYNAMICALLY RECONFIGURING ROBOT COMPONENTS

(75) Inventors: Seung-Woog JUNG, Daejeon (KR); Myung Eun KIM, Daejeon (KR); Young-Jo CHO, Daejeon (KR); Sung Hoon KIM, Daejeon (KR)

(73) Assignee: Electronics and Telecommunications Research Institute, Daejon (KR)

(21) Appl. No.: 13/235,584

(22) Filed: Sep. 19, 2011

(30) Foreign Application Priority Data
Sep. 20, 2010 (KR) 10-2010-0092549
Dec. 22, 2010 (KR) 10-2010-0132247

(51) Int. Cl. G05B 19/04

(52) U.S. Cl. 700/250; 901/30

(57) ABSTRACT

An apparatus for reconfiguring robot components in an environment that includes a robot terminal apparatus, including a plurality of internal components, and external components, interacting with the internal components, includes a situation monitoring unit for checking whether there has been a change in a situation of the robot terminal apparatus. Further, the apparatus includes a component availability analysis unit for determining at least one available component that belongs to the internal components or the external components; and a component search unit for searching for at least one component based on results of the determination of the component availability analysis unit. Furthermore, the apparatus includes a component dependency analysis unit for analyzing a dependency relationship between the component found by the component search unit and the component determined to be available by the component availability analysis unit; and a component reconfiguration unit for reconfiguring a connection relationship between the components.

### CROSS-REFERENCE TO RELATED APPLICATION(S)

The present invention claims priority of Korean Patent Application No. 10-2010-0092549, filed on Sep. 20, 2010, and Korean Patent Application No. 10-2010-0132247, filed on Dec. 22, 2010, which are incorporated herein by references.

### FIELD OF THE INVENTION

The present invention relates to technology for reconfiguring robot components; and more particularly, to a method and apparatus for reconfiguring robot components, which are suitable for dynamically reconfiguring components being executed in a robot in response to a change in the situation of the robot.

### BACKGROUND OF THE INVENTION

Recent robots are being developed to provide a wider variety of services while interacting with their surroundings, rather than solely providing services. An example is the case where a robot controls home electronic appliances or a robot monitors the situation in a house while operating in conjunction with cameras installed in the house. When a robot moves from a main bedroom to a living room, the robot needs to continue to monitor a house using an image captured by a camera installed in the living room instead of a camera installed in the main bedroom.

When there has been a change in the situation of a robot as described above, the robot needs to be able to reconfigure components, being executed therein, in accordance with a new situation and to continue to perform an existing service in accordance with the new situation.

### SUMMARY OF THE INVENTION

In view of the above, the present invention provides technology for reconfiguring robot components, which is capable of reconfiguring components, being executed inside or outside a robot that is performing a service while interacting with its surroundings, in accordance with a new situation if there has been a change in the situation inside or outside the robot, thereby being able to continue to provide an existing service.

In accordance with a first aspect of the present invention, there is provided an apparatus for reconfiguring robot components in an environment that includes a robot terminal apparatus, including a plurality of internal components, and external components, existing outside the robot terminal apparatus and interacting with the internal components.

The apparatus for reconfiguring the robot components includes a situation monitoring unit for checking whether there has been a change in a situation of the robot terminal apparatus; a component availability analysis unit for determining at least one component that belongs to the internal components or the external components and that is available in accordance with a change in the situation of the robot terminal apparatus based on results of the checking of the situation monitoring unit; a component search unit for searching for at least one component based on results of the determination of the component availability analysis unit; a component dependency analysis unit for analyzing a dependency relationship between the component found by the component search unit and the component determined to be available by the component availability analysis unit; and a component reconfiguration unit for reconfiguring a connection relationship between the components based on the dependency relationship between the components analyzed by the component dependency analysis unit.

In accordance with a second aspect of the present invention, there is provided a method of reconfiguring robot components, including monitoring a current situation of a robot terminal apparatus; if, as a result of the monitoring of the situation, it is determined that there has been a change in the situation of the robot terminal apparatus, determining whether there is at least one unavailable component by analyzing component availability; if, as a result of the determination, it is determined that there is no unavailable component, searching for a component available in accordance with the change in the situation of the robot terminal apparatus; analyzing a dependency relationship of the available component; and if, as a result of the searching and the analysis, it is determined that there is a component in the robot terminal apparatus, reconfiguring the component and executing a component not being executed. In accordance with the embodiment of the present invention, if there has been a change in the situation of a robot, the components of the robot terminal apparatus are reconfigured in accordance with the new situation so that an existing service can be continuously provided. Accordingly, service continuity and a more accurate and reliable robot service environment can be provided.

### BRIEF DESCRIPTION OF THE DRAWINGS

The objects and features of the present invention will become apparent from the following description of embodiments given in conjunction with the accompanying drawings, in which:

FIG. 1 is a block diagram showing the configuration of an apparatus for reconfiguring robot components in accordance with an embodiment of the present invention;

FIG. 2 is a diagram illustrating the configuration of an example for dynamically reconfiguring robot components in accordance with an embodiment of the present invention; and

FIG. 3 is a flowchart illustrating a method of reconfiguring robot components in accordance with an embodiment of the present invention.

### DETAILED DESCRIPTION OF THE EMBODIMENTS

Embodiments of the present invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective sequences of the sequence diagram.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

The present invention is intended to effectively reconfigure the internal and external components of a robot terminal apparatus in accordance with a change in the situation inside or outside the robot terminal apparatus, in an environment that includes the robot terminal apparatus, including a plurality of internal components, and external components, existing outside the robot terminal apparatus and interacting with the internal components of the robot terminal apparatus.

A component refers to a reusable and replaceable robot software module. It may have a standardized structure so that a robot application can be easily developed, maintained, and repaired. In order for one component to communicate with another, the former component needs to be connected to the latter component. The connection of one component to anther means that the two components have the addresses of their counterpart.

Embodiments of the present invention will be described in detail below with reference to the accompanying drawings which form a part hereof.

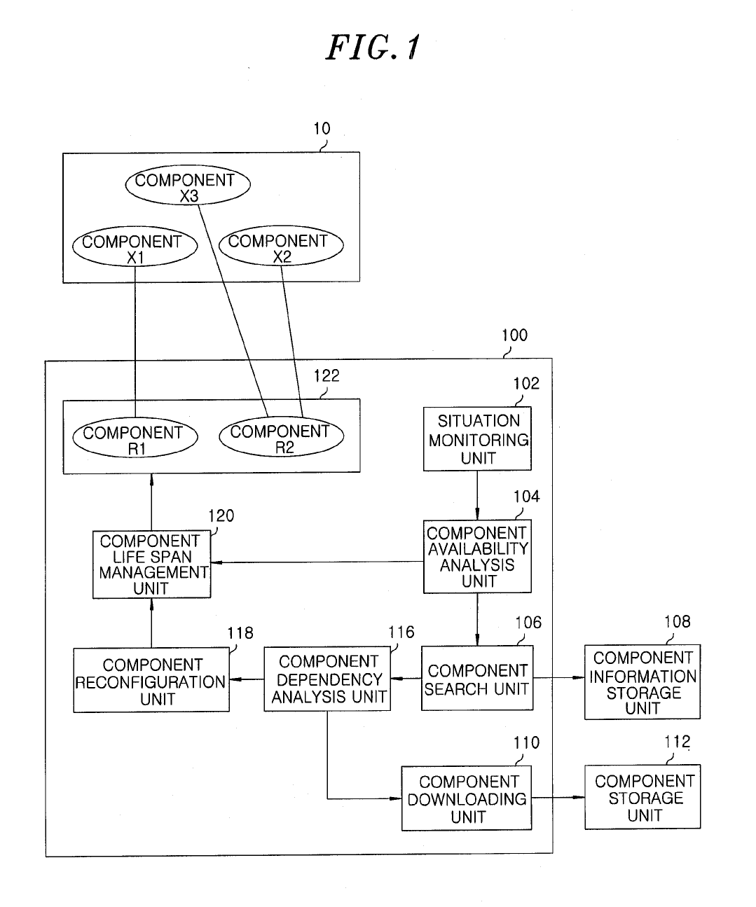

FIG. 1 is a block diagram showing the configuration of an apparatus for reconfiguring robot components in accordance with an embodiment of the present invention. The apparatus includes external components 10; a robot terminal apparatus 100 including a situation monitoring unit 102, a component availability analysis unit 104, a component search unit 106, a component downloading unit 110, a component dependency analysis unit 116, a component reconfiguration unit 118, a component life span management unit 120, and internal components 122; a component information storage unit 108; and a component storage unit 112.

As shown in FIG. 1, the apparatus for reconfiguring robot components in accordance with the embodiment of the present invention includes a system environment that includes the robot terminal apparatus 100 including the plurality of internal components 122 and external components 10 interacting with the internal components 122 of the robot terminal apparatus 100.

Here, the situation monitoring unit 102 of the robot terminal apparatus 100 functions to check whether there has been a change in the situation of the robot terminal apparatus 100.

The component availability analysis unit 104 functions to determine one or more currently available internal components 122 and/or external components 10 in accordance with a change in the situation of the robot terminal apparatus 122, based on the results of the checking of the situation monitoring unit 102 (e.g., if it is determined that there has been a change in the situation of the robot terminal apparatus 100).

The component search unit 106 functions to search for one or more components based on the results of the determination of the component availability analysis unit 104 (e.g., available components in accordance with the change in the situation of the robot terminal apparatus 100).

The component information storage unit 108 stores information about all of the components, and the component search unit 106 searches for, e.g., components available in accordance with the change in the situation.

The component dependency analysis unit 116 functions to analyze the dependency relationship between the components retrieved by the component search unit 106 and the components determined to be available by the component availability analysis unit 104.

The component downloading unit 110 functions to download one or more components that belong to components based on the results of the analysis of the component dependency analysis unit 116 and that are not present in the robot terminal apparatus 100. For example, the component downloading unit 110 downloads one or more components that are analyzed as components which need to be executed in the robot terminal apparatus 100 and that are not present in the robot terminal apparatus 100.

The component storage unit 112 functions to store the components that have been downloaded by the component downloading unit 110.

The component reconfiguration unit 118 functions to reconfigure the connection relationship between the components based on the dependency relationship between the components, which was analyzed by the component dependency analysis unit 116.

The component life span management unit 120 functions to stop the execution of the components reconfigured by the component reconfiguration unit 118 and the components analyzed by the component availability analysis unit 104, or functions to execute the stopped components again.

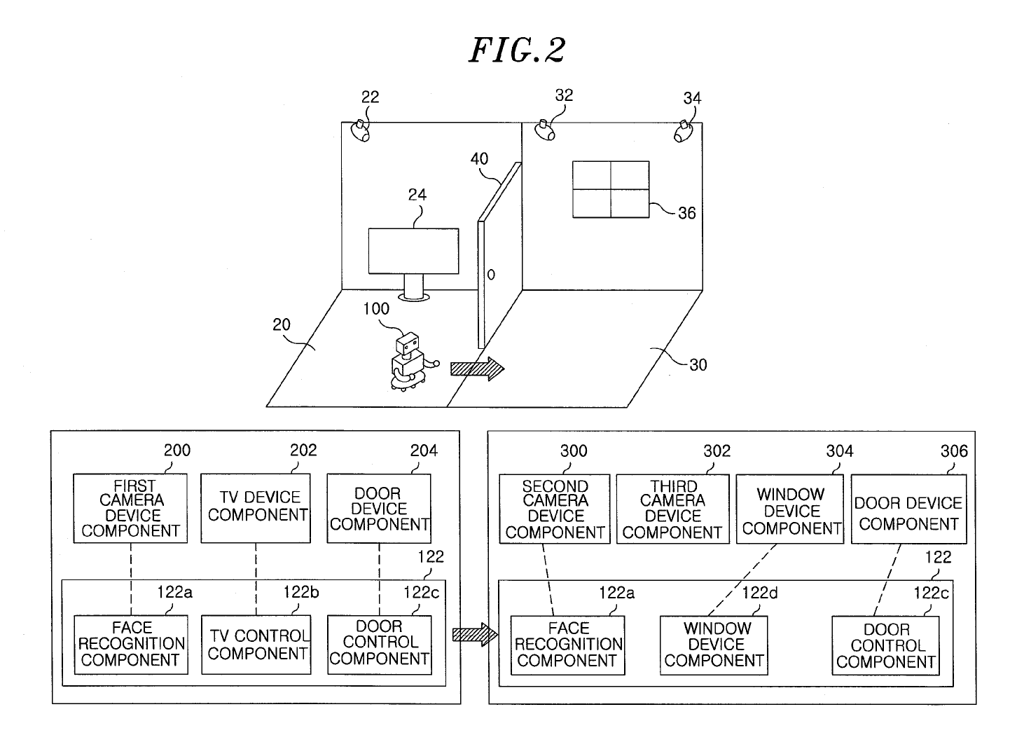

FIG. 2 is a diagram illustrating the configuration of an example for dynamically reconfiguring robot components in accordance with an embodiment of the present invention.

As shown in FIG. 2, a first camera device 22, a TV device 24, and the robot terminal apparatus 100 are present in a main bedroom 20, and a second camera device 32, a third camera device 34, and a window device 36 is present in a living room 30. Furthermore, a door device 40 is present between the main bedroom 20 and the living room 30. It is assumed that the robot terminal apparatus 100 moves from the main bedroom 20 to the living room 30 through the door device 40.

First, if the robot terminal apparatus 100 is located in the main bedroom 20, a first camera device component 200 responsible for a connection with the first camera device 22 is present in the first camera device 22, a TV device component 202 responsible for a connection with the TV device 24 is present in the TV device 24, and a door device component 204 responsible for a connection with the door device 40 is present in the door device 40.

Furthermore, the internal components 122 of the robot terminal apparatus 100 includes a face recognition component 122a configured to recognize the face of a person in a camera image from the first camera device component 200 by analyzing the camera image, a TV control component 122b connected to the TV device component 202 and configured to be responsible for functions such as the on and off, volume, and channel control of the TV device 24, and a door control component 122c connected to the door device component 204 and configured to perform the function of opening or shutting the door device 40.

The face recognition component 122a, the TV control component 122b, and the door control component 122c are internal components that are present inside the robot terminal apparatus 100. The first camera device component 200, the TV device component 202, and the door device component 204 are external components that are present outside the robot terminal apparatus 100.

When the robot terminal apparatus 100 moves from the main bedroom 20 to the living room 30, the first camera device component 200 for controlling the first camera device 22 and the TV device component 202 for controlling the TV device 24 that are present in the main bedroom 22 are no longer used in the living room 30. A door device component 306 is present between the main bedroom 20 and the living room 30, and thus continues to be used.

Accordingly, a connection between the first camera device component 200 and the face recognition component 122a that are unavailable components and a connection between the TV device component 202 and the TV control component 122b that are unavailable components may be released.

Thereafter, when the robot terminal apparatus 100 reaches the living room 30, it searches for one or more components available in the living room 30. Newly found components, other than existing components, includes a second camera device component 300 responsible for a connection with the second camera device 32, a third camera device component 302 responsible for a connection with the third camera device 34, a window device component 304 responsible for a connection with the window device 36, and a window device component 122d.

The dependency relationship between the found components and existing internal components (i.e., the face recognition component 122a, the TV control component 122b, and the door control component 122c) is analyzed. The face recognition component 122a is connected to the second camera device component 300 that is selected from between the second camera device component 300 and the third camera device component 302 and that is a component suitable for recognizing a face. The execution of the TV control component 122b is stopped because a TV device component available in the living room 30 is not present.

Furthermore, the window device component 304 is connected to the window device component 122d that is not present in the robot terminal apparatus 100. Accordingly, the window device component 304 is downloaded, connected to the window device component 122d, and then executed.

As in the above embodiment, in accordance with the present invention, if there has been a change in the surrounding situation because the robot terminal apparatus 100 has moved from the main bedroom 20 to the living room 30, components are executed in accordance with a new situation by searching for, downloading, and reconfiguring components.

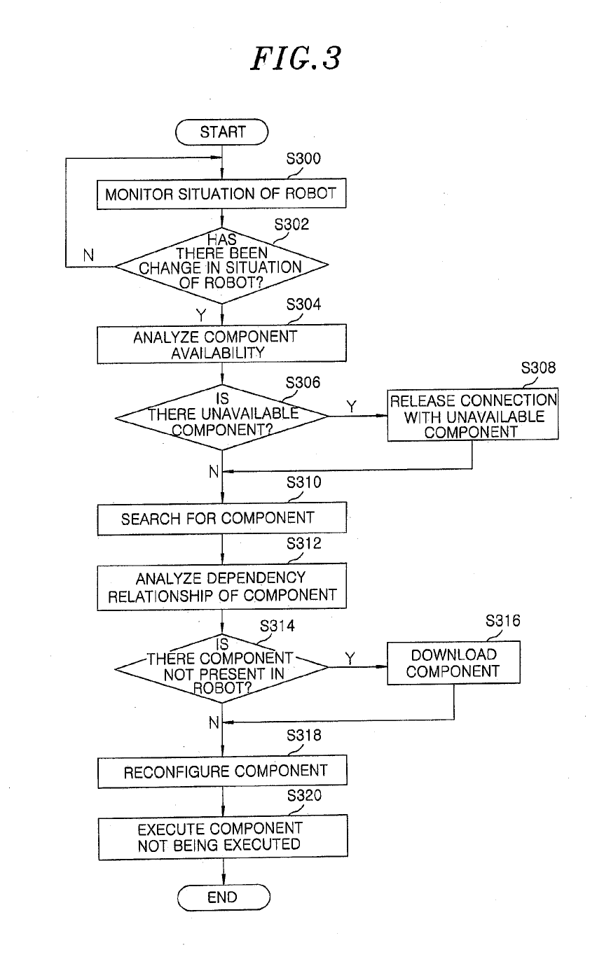

FIG. 3 is a flowchart illustrating a method of reconfiguring robot components in accordance with an embodiment of the present invention.

As shown in FIG. 3, the situation monitoring unit 102 monitors the current situation of the robot terminal apparatus 100 in step S300.

If, as a result of the monitoring of the situation monitoring unit 102, it is determined in step S302 that there has been a change in the situation of the robot terminal apparatus 100, the component availability analysis unit 104 determines whether there is an unavailable component by analyzing the availability of components in steps S304 and S306.

If, as a result of the determination in step S306, it is determined that an unavailable component is present, the component life span management unit 120 releases a connection with the unavailable component (i.e., stop the execution of the unavailable component) in step S308.

In contrast, if, as a result of the determination in step S306, it is determined that there is no unavailable component, the component search unit 106 searches for a component available in accordance with the change in the situation of the robot terminal apparatus based on the result of the analysis of the component availability analysis unit 104 in step S310, and the component dependency analysis unit 116 analyzes the component dependency relationship in step S312.

If, as a result of the analysis of the component dependency relationship, it is determined that there is a component that is not present in the robot terminal apparatus 100 in step S314, the component downloading unit 110 downloads the component in step S316.

On the other hand, if it is determined that there is a component that is present in the robot terminal apparatus 100, the component reconfiguration unit 118 reconfigures the component in step S318, and the component life span management unit 120 executes a component that is not being executed in step S320.

The change in the situation of the robot terminal apparatus 100 includes not only a change in location, such as the case where the robot terminal apparatus 100 has moved from the main bedroom to the living room, but also the case where a component (e.g., a camera device) in the main bedroom has failed or a new device, such as a window device, has been installed in the main bedroom.

The following Table 1 illustrates component information that is used when a component is searched for in accordance with an embodiment of the present invention.

TABLE 1

| | |
|---|---|
| ID | cd6034.12a3148e840.37.2314 |
| Name | camera0 |
| Address | tcp://127.0.0.1:1234 |
| Location | main bedroom |
| Function | image |

| | | |
|---|---|---|
| Attribute | image width | 320 |
| | image height | 240 |
| | color | Yes |
| | pixel per byte | 3 |

As can be seen from Table 1, in order to search for a component, information such as a component identification (ID), a component name, a component address, a component position, a component function and a component attribute, may be used.

While the invention has been shown and described with respect to the embodiments, it will be understood by those skilled in the art that various changes and modifications may be made without departing from the scope of the invention as defined in the following claims.

What is claimed is:

1. An apparatus for reconfiguring robot components in an environment that includes a robot terminal apparatus, including a plurality of internal components, and external components, existing outside the robot terminal apparatus and interacting with the internal components, the apparatus comprising:
a situation monitoring unit for checking whether there has been a change in a situation of the robot terminal apparatus;
a component availability analysis unit for determining at least one component that belongs to the internal components or the external components and that is available in accordance with a change in the situation of the robot terminal apparatus based on results of the checking of the situation monitoring unit;
a component search unit for searching for at least one component based on results of the determination of the component availability analysis unit;
a component dependency analysis unit for analyzing a dependency relationship between the component found by the component search unit and the component determined to be available by the component availability analysis unit; and
a component reconfiguration unit for reconfiguring a connection relationship between the components based on the dependency relationship between the components analyzed by the component dependency analysis unit.

2. The apparatus of claim 1, wherein the component availability analysis unit determines the at least one available component that belongs to the internal components or the external components and that is available in accordance with the change in the situation of the robot terminal apparatus.

3. The apparatus of claim 1, wherein the component search unit searches for the at least one component available in accordance with the change in the situation of the robot terminal apparatus.

4. The apparatus of claim 1, further comprising a component information storage unit for storing information about the components, which can be searched by the component search unit for a specific component.

5. The apparatus of claim 4, wherein the specific component is the component available in accordance with the change in the situation.

6. The apparatus of claim 1, further comprising a component downloading unit for downloading at least one component that belongs to the components based on results of the analysis of the component dependency analysis unit and that is not present in the robot terminal apparatus.

7. The apparatus of claim 6, wherein the components that are based on the results of the analysis of the component dependency analysis unit are components that are analyzed as components which should be executed in the robot terminal apparatus.

8. The apparatus of claim 6, further comprising a component storage unit for storing the component that is downloaded by the component downloading unit.

9. The apparatus of claim 1, further comprising a component life span management unit for stopping execution of the components reconfigured by the component reconfiguration unit and the components analyzed by the component availability analysis unit, or for executing stopped components.

10. A method of reconfiguring robot components, comprising:
monitoring a current situation of a robot terminal apparatus;
if, as a result of the monitoring of the situation, it is determined that there has been a change in the situation of the robot terminal apparatus, determining whether there is at least one unavailable component by analyzing component availability;
if, as a result of the determination, it is determined that there is no unavailable component, searching for a component available in accordance with the change in the situation of the robot terminal apparatus;
analyzing a dependency relationship of the available component; and
if, as a result of the searching and the analysis, it is determined that there is a component in the robot terminal apparatus, reconfiguring the component and executing a component not being executed.

11. The method of claim 10, further comprising, if the determination reveals that there is at least one unavailable component, releasing a connection with the unavailable component.

12. The method of claim 11, wherein said releasing the connection with the unavailable component comprises stopping execution of the unavailable component.

13. The method of claim 10, further comprising, if it is determined that there is at least one component that is not present in the robot terminal apparatus as a result of said searching and analyzing, downloading the component.

14. The method of claim 10, wherein whether there has been a change in the situation of the robot terminal apparatus is determined when the robot terminal apparatus has moved from a location to another or a component device has been added.

15. The method of claim 10, wherein information about the available component used in the searching comprises one or more of a component ID (identification), a component name, a component address, a component location, a component function, and a component attribute.
